(19) United States
(12) Patent Application Publication
(10) Pub. No.: US 2022/0227629 A1
(43) Pub. Date: Jul. 21, 2022

(54) CARBON NANOTUBE NANOCOMPOSITE BASED LITHIUM-ION BATTERY

(71) Applicant: KHALIFA UNIVERSITY OF SCIENCE AND TECHNOLOGY, Abu Dhabi (AE)

(72) Inventors: Daniel CHOI, Abu Dhabi (AE); Amarsingh Bhabu KANAGARAJ, Abu Dhabi (AE); Prena CHATURVEDI, Abu Dhabi (AE); Maryam Sultan AL NAHYAN, Abu Dhabi (AE); Hamda AL SHIBLI, Abu Dhabi (AE)

(21) Appl. No.: 17/287,967

(22) PCT Filed: Jan. 15, 2020
(86) PCT No.: PCT/IB2020/050284

§ 371 Date: Apr. 22, 2021

Related U.S. Application Data
(60) Provisional application No. 62/823,345, filed on Mar. 25, 2019.

(51) Int. Cl. C01B 25/45; H01M 4/62; H01M 4/04; H01M 4/485; H01M 10/0525; H01M 4/131; H01M 4/133; H01M 4/583; H01M 4/36

(52) U.S. Cl. CPC C01B 25/45; H01M 4/623; H01M 4/0471; H01M 4/485; H01M 10/0525; B82Y 40/00; H01M 4/133; H01M 4/583; H01M 4/364; C01P 2004/64; H01M 4/131

(57) ABSTRACT

The present invention discloses a hydrothermal process of preparing lithium iron phosphate (LiFePCO₄) nanoparticles. It further discloses a composite electrode comprising lithium iron phosphate, multiwalled carbon nanotubes (MWCNTs) and polyvinylidene fluoride as well as a method of manufacturing this composite electrode. It also discloses a free-standing composite electrode comprising spinel-Li₄Ti₅O₁₂, multiwalled carbon nanotubes and carboxymethyl cellulose as well as a method of manufacturing this free-standing composite electrode.

### FIELD OF THE INVENTION

The present invention relates to the field of nanostructured lithium-ion batteries, and in particular to carbon nanotube nanocomposite based flexible lithium ion battery.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Most recently, Lithium (Li) ion based battery materials have been extensively investigated for its potential application in electric vehicles (EV) and hybrid electric vehicles (HEV). Olivine structured LiFePO₄ has now under rapid research as the most competitive cathode material for Li-ion batteries, because of its environmental compatibility, high chemical and thermal stability and excellent electrochemical performances. However, some poor kinetic factors limited its availability for practical uses, such as low electronic conductivity (10⁻⁸ to 10⁻⁹ Scm⁻¹) and low Li diffusivity (10⁻¹⁴ to 10⁻¹⁷ cm²s¹). Numerous effective approaches have been made to overcome the factors, for instance, conductive inorganic carbon or organic polymer coating, metallic cation doping, particle size reduction and controllable particle morphology. In general, conductive carbon coating and particle size reduction are the important key factors for increasing the performances of LiFePO₄-based Li-ion batteries in terms of capacity and rate capability. In addition, the overall electrochemical performances of LiFePO₄ particles are closely related to its tunable morphology and crystal orientation. For example, Lin et al have synthesized and studied self-assembled various shape of particles such as cube-cluster, dumbbell, rod and rugby shaped LiFePO₄/C/RGO composites by hydrothermal method. Rod and rugby like shaped composites exhibited higher discharge capacity and better cyclic performances compared with cube-cluster and dumbbell like shaped composites. Cyclic discharge capacities for rugby and cube cluster like shaped LiFePO₄/C/RGO composites are 155 mAh/g and 50 mAh/g, respectively at 0.1 C. Tang et al have prepared LiFePO₄ thin films through solid state reaction and deposited on polished substrates using pulsed-laser deposition under different argon pressure (10, 20, 30 and 40 Pa). Thin films deposited at 40 Pa depicted the cone-shaped grains with specific capacity value of 16 μAh/μm cm² at 0.25 C. Herrera et al have prepared yttrium doped LiFePO₄ cathode materials by hydrothermal method with semispherical and broccoli shaped particles. Broccoli shaped particles showed a specific capacity value of 27.5 mAh/g at first cycle. LiFePO₄ particles with plate-like rhombus crystal morphology that were prepared by a mild hydrothermal process were studied by Martins et al. At 0.2 C, plate-like rhombus shaped LiFePO₄ particles exhibited the discharge capacity value of 35 mAh/g. So controlling the morphologies and improving the electrochemical performances remains an issue. Hence, further development needs to increase the electrochemical performances by controlling the morphologies with desired synthetic techniques.

Several synthesis techniques have been employed to fabricate high quality LiFePO₄ cathode materials such as sol-gel, hydrothermal, solvothermal, co-precipitation, solid state reaction etc. Among the various preparation methods, hydrothermal synthesis is a simple, cost effective and environmentally benign method to prepare olivine LiFePO₄ with homogeneous particle size, high particle distribution and well-defined morphologies even at low temperature.

This present research deals with the current advancement and investigates the influence of different reaction hours on structural and electrochemical properties of LiFePO₄ particles. It was found that various shape of the micrometer-scale LiFePO₄ particles such as ‘seeds’ and ‘capsules’ were synthesized as a result of the hydrothermal process. Morphology and crystal orientation of the LiFePO₄ particles can be controlled by differing the reaction hours.

Due to highest gravimetric and volumetric energy densities, Li-ion batteries (LIBs) have become dominant power sources for portable appliances as well as high-end applications viz., electric vehicles and hybrid electric vehicles, spacecraft, etc. However, at high current rate, the capacity loss increases rapidly due to side reactions, such as electrolyte decomposition, solid electrolyte interface formation and active material dissolution. Hence, extensive research is being carried out to develop novel electrode materials with improved safety and long cycle life at high current rate. In this regard, Spinel-Li₄Ti₅O₁₂ (LTO) has attracted gigantic attention as a promising alternative anode material compared to traditional graphite due to almost zero structural change during insertion and deinsertion of Li-ions, high rate capability and thermal stability. Furthermore, LTO is a cheaper, non-toxic, easily produced anode and has Li/Li⁺ potential plateau at ˜1.55 V. Despite these advantages, LTO shows high polarization resistance at high current rate due to its low electrical conductivity (10⁻¹³ Scm⁻¹) and lithium diffusivity. To overcome this problem considerable efforts have been made such as doping, particle size reduction, carbon coating etc. Carbon coating is one of the interesting approach to improve the overall performance of anode materials. Among them, multi-walled carbon nanotubes (MWCNTs) are promising material due to their three dimensional conductive network, high mechanical, thermal and electrical properties. Here, we are proposing a novel MWCNTs supported LTO free-standing electrode that is prepared by simple and cost-effective surface engineered tape casting method. Such a free-standing electrode may also replace copper as a current collector owing to its excellent electrical conductivity and enhanced electrochemical properties.

In the present study, the overall performance of MWCNTs supported freestanding LTO electrode is well compared with the commercially available LTO. To the best of our knowledge, the improved performance of MWCNTs supported LTO electrode via surface-engineered tape casting method is presented for the first time.

Olivine-type lithium iron phosphate (LiFePO₄) has received considerable attention as a cathode material for Li-ion batteries (LIB) due to its low cost, environmental friendliness and high theoretical specific capacity (˜170 mAh/g). In the design of full-cell, the rational selection of positive and negative electrode material is crucial. Since both electrode materials are different, mass load balance needs to be performed. Typically, the specific capacity of most of the cathode materials is lower than that of anode materials, so that a large amount of cathode material needs to be loaded in order to ensure the performance of full-cell. Furthermore, the specific capacity of LiFePO₄ on aluminum foil used to be observed as lower than the theoretical values due to inactive materials. Hence, a new free-standing substrate with high porosity, excellent conductivity and electrochemical properties is required. Multi-walled carbon nanotubes (MWCNT) have been studied as a suitable current collector due to its superior electrical conductivity, exceptional mechanical and thermal properties. Susantyoko et al. have shown free-standing tape-casted LiFePO₄/MWCNTs buckypaper as cathode for LIB with specific capacity of ˜160 mAh/g.

In this paper, LiFePO₄ particles have been synthesized through a simple, environment friendly hydrothermal process. LiFePO₄/MWCNT composite electrodes were prepared through a wet-filtration-zipping technique following Patole et al. To the best of our knowledge, mechanical performance of LiFePO₄/MWCNT composite electrodes prepared through wet-filtration zipping technique is presented for the first time.

There are a number of conventional rechargeable batteries developed and meet the energy requirements of wearable device applications. However, they still struggle to achieve flexibility, lightweight and thinness. Even though some of the researchers demonstrated a sort of flexible LIBs with a small scale, such a process may not be feasible for mass production due to complexity in fabrication. As an example, they fabricated double layers of cathodes or anodes with slurry coating of LiCoO₂ (LCO) or CNT and LTO films on CNTs and peel off the bi-layers of CNT/LCO or CNT/LTO, which is a low yield process. A full-cell solid-state flexible battery has not been fabricated since a solid electrolyte is not included.

### SUMMARY OF THE INVENTION

In the present invention the inventors have developed:

1. High performance CNT nanocomposites cathode (mixture of CNTs and LiFePO₄ nano/micro-particles): maximum size of the sheet of CNT nanocomposites is about 15 cm×15 cm×500 micron and specific energy capacity of 106 mAh/g at 1 C-rate.

2. High performance CNT nanocomposites anode (mixture of CNTs and LTO nano/micro-particles): maximum size of the sheet of CNT nanocomposites is about 15 cm×15 cm×500 micron and specific energy capacity of 155 mAh/g at 1 C-rate.

3. High ionic conductivity PEO-based solid electrolyte thin-films (with size of 20 cm×20 cm×100 microns and ionic conductivity of 1×10⁻⁵ Scm⁻¹).

The flexible LIB that is being developed in the present invention is composed of carbon nanotube (CNT) nanocomposite cathode (CNT+LiFePO₄ nano/micro-particles), polyethylene oxide (PEO)-based solid electrolyte films and CNT nanocomposite anode.

The followings aspects are included:

(1) Processes for fabrication of individual components such as nanocomposite cathode, nanocomposite anode and thin-film solid electrolytes;

(2) Integration of three components (cathode, anode and solid electrolytes) into full-cell flexible LIB batteries;

(3) ‘Roll-to-Roll’ process that enables mass production of the above flexible LIB.

1. Development of nanocomposite cathodes: Fabrication of LiFePO₄ nano/micro-particles and cathode nanocomposites of LiFePO₄/MWCNTs

LiFePO₄ nano/micro-particles can be prepared by a hydrothermal process. Precursor solution was prepared with the chemicals of 3 M of LiOH, 1 M of FeSO₄, 1 M of L-ascorbic acid, 1 M of H₃PO₄ mixed with 5 mL of de-ionized water/ethylene glycol (volumetric ratio 1/1) medium. Here, L-ascorbic acid acted as a reducing agent to reduce the Fe³⁺ to Fe²⁺ and prevent oxidation of Fe²⁺. Then the mixture was subjected to intensive magnetic stirring at 800 RPM for 1 hour at room temperature. The resulting homogeneous mixture was quickly transferred to a 23 mL Teflon lined stainless steel autoclave and placed in a timer controlled oven. The autoclave was heated and maintained at 160° C. for 12 hours under air atmosphere. Subsequently, the autoclave was cooled down naturally to room temperature. Precipitates were recovered by centrifugation and washed several times with deionized water and dried at 80° C. in an oven under air atmosphere for overnight. Subsequently, the dried LiFePO₄ particles were placed in a tubular furnace and annealed at 700° C. for 6 h under argon (Ar)-atmosphere. After thermal treatment the LiFePO₄ particles were ball-milled using 5 mm zirconia balls for 4 h in 10 mL ethanol medium. Ball to sample mass ratio was 20:1. Next, the precipitates were collected and dried at 80° C. in an oven under air atmosphere for overnight.

Free-standing cathode nanocomposites of LiFePO₄ particles/multi-walled carbon nanotubes (MWCNTs) were prepared by a surface-engineered tape-casting technique. The synthesized LiFePO₄ particles, MWCNTs were mixed with the weight ratio of 70:25:5. Then, the mixture was added with water/Ethanol (volumetric ratio 50/50) solvents and softly grinded using mortar and pestle for 2 minutes. Further, the slurry was transferred to a beaker and sonicated for 10 minutes. During sonication, slurry was stirred simultaneously using a hot plate stirrer at room temperature for better particle dispersion. The prepared slurry was stirred for overnight. LiFePO₄/MWCNTs composites electrodes has been prepared with a tape casting blade gap of 3 mm Prior to casting, slurry was placed in a vacuum oven for 1 minute for the degasification purpose. Subsequently, the prepared slurry was coated on a piece of copper foil and placed in an oven at 120° C. for 1 h in ambient. After that, the working electrodes has been de-attached from the copper foil and acted as a free-standing composite cathode electrode. FIG. 1 is a schematic diagram illustrating the procedure for fabrication of cathode nanocomposites of LiFePO₄ nano/micro-particles and MWCNTs. FIG. 2 shows the photo of free-standing cathode nanocomposites of LiFePO₄ nano/micro-particles and MWCNTs. FIG. 3 is the scanning electron microscope (SEM) image of free-standing cathode nanocomposites of LiFePO₄ nano/micro-particles and MWCNTs.

Novelty: The optimized processes for fabrication of cathode nanocomposites with high battery performance (specific energy capacity of about 106 mAh/g at 1C rate) and less than 10% degradation in specific energy capacity of the cathodes even after more than 60 cycles of charging and discharging, uniformly distributed LiFePO₄ particles within MWCNT matrix, good crystal quality of LiFePO₄ particles, good control of thickness of cathode nanocomposites.

2. Development of nanocomposite anodes: Fabrication of Li₄Ti₅O₁₂ (LTO) micro-particles and anode nanocomposites of LTO and MWCNTs

Li₄Ti₅O₁₂ (LTO) micro-particles were synthesized by a wet-milling route using 1.073 g of Li₂CO₃ and 2.897 g of TiO₂ (VWR, <500 nm) with ethanol as media. All the precursors were ball-milled at 400 rpm for 5 h using full-directional planetary ball mill in zirconia jar (50 ml) with zirconia balls (5 mm). Ball to sample mass ratio was 20:1. The resulting mixture was dried in air and later annealed at 850° C. for 26 h in muffle furnace, followed by grinding for 1 hour.

LTO micro-particles/MWCNTs free-standing composite cathode electrodes were prepared by a surface-engineered tape-casting technique. The synthesized LTO particles, MWCNTs and carboxymethyl cellulose were mixed with the weight ratio of 70:25:5. Then, the mixture was added with water/Ethanol (volumetric ratio 50/50) solvents and softly grinded using mortar and pestle for 2 minutes. Further, the slurry was transferred to a beaker and sonicated for 10 minutes. During sonication, slurry was stirred simultaneously using a hot plate stirrer at room temperature for better particle dispersion. The prepared slurry was stirred for overnight. LTO/MWCNTs composites electrodes has been prepared with a tape casting blade gap of 3 mm. Prior to casting, slurry was placed in a vacuum oven for 1 minute for the degasification purpose. Subsequently, the prepared slurry was coated on a piece of copper foil and placed in an oven at 120° C. for 1 h in ambient. After that, the working electrodes has been de-attached from the copper foil and acted as a free-standing composite anode electrode. FIG. 4 shows the photo of free-standing anode nanocomposites of LTO micro-particles and MWCNTs. FIG. 5 is the SEM image of free-standing anode nanocomposites of LTO micro-particles and MWCNTs.

(Novelty: The optimized processes for fabrication of anode nanocomposites with high battery performance (specific energy capacity of about 155 mAh/g at 1C rate) and less than 10% degradation in specific energy capacity of the anodes even after more than 40 cycles of charging and discharging, uniformly distributed LTO particles within MWCNT matrix, good crystal quality of LTO particles, good control of thickness of anode nanocomposites).

3. Development of Solid Electrolytes: Fabrication of PEO/LiFTSI Solid Electrolyte Films

Polyethylene oxide (PEO)/Lithium bis(trifluoromethanesulfonyl)imide (LiTFSI) solid electrolyte films were prepared in an argon filled glove box (H₂O and O₂<1 ppm) by using drop casting method. Acetonitrile was used as a solvent. The concentration of lithium salt in the polymer electrolytes was determined by the molar ratio of —CH₂CH₂O— (EO)/Li+(i.e., [EO unit] to [Li+]). Molar ratio of ((EO)/Li+) 20 was used. Firstly, 0.75 g of PEO was mixed with 20 mL of Acetonitrile and stirred for 12 hours. Next, 0.25 g of LiTFSI was mixed with 3 mL of Acetonitrile and stirred for 4 hours. Then, the both mixtures were mixed together and stirred for 24 hrs. Subsequently, the mixture was drop casted on Teflon substrate at different thickness, following by evaporation and drying at room temperature at least 48 h under high vacuum conditions. FIG. 6 a, b shows the SEM images of PEO/LiFTSI solid electrolyte films: Top view (FIG. 6A) and cross-sectional view (FIG. 6B).

(Novelty: The optimized processes for fabrication of solid electrolytes with high ionic conductivity of about 10⁻⁵ S/cm, good adhesion with cathode nanocomposites and anode nanocomposites based on MWCNTs, good control of thickness of solid electrolytes).

4. Integration of Full-Cell Battery

Once free-standing and flexible all the major battery components (cathode nanocomposites, anode nanocomposites and solid electrolyte films) are ready, those are integrated to build full-cell batteries. FIG. 7 shows a schematic diagram showing a few steps towards integration of three components to build a full-cell battery.

As the first step, the PEO-based solid electrolyte films are compressed with cathode nanocomposites to integrate the both layers. Mechanical compression with a hot press machine was used to reduce the thickness of polymer electrolyte as well as to improve the interconnectivity between anode/polymer electrolyte/cathode. Firstly, PEO-based solid electrolyte films was compressed with a load of 1000 kg for 10 min at room temperature. Then, the polymer electrolyte compressed together with LiFePO₄ composite cathode electrode with a load of 1000 kg for 10 min at room temperature. FIGS. 8 a, b show the SEM images of cross-sectional view of the integrated cathode nanocomposite and PEO-based solid electrolyte films.

(Novelty: The optimized mechanical compression processes for integration of three major battery components—cathode nanocomposites, solid electrolytes and anode nanocomposites).

5. ‘Roll-to-Roll’ Process for Scale-Up (Mass Production)

For the purpose of mass production, ‘Roll-to-Roll’ process similar to the one for manufacturing of organic solar cells can be implemented. FIG. 9 shows a schematic diagram showing a few steps designed for ‘Roll-to-Roll’ process towards mass production of flexible Li-ion batteries.

(Novelty: The ‘Roll-to-Roll’ process that is designed for mass production of flexible Li-ion batteries with two pre-produced rolls of battery components such as cathode nanocomposites and anode nanocomposites.

### BRIEF DESCRIPTION OF THE DRAWINGS

The subject matter that is regarded as the invention is particularly pointed out and distinctly claimed in the claims at the conclusion of the specification. The following drawings form part of the present specification and are included to further demonstrate certain aspects of the present invention, the inventions of which can be better understood by reference to one or more of these drawings in combination with the detailed description of specific embodiments presented herein. The foregoing and other aspects, features, and advantages of the invention are apparent from the following detailed description taken in conjunction with the accompanying drawings in which:

FIG. 1 Schematic diagram illustrating the procedure for fabrication of cathode nanocomposites of LiFePO₄ nano/micro-particles and MWCNTs.

FIG. 2 illustrates photo of free-standing and flexible cathode nanocomposites of LiFePO₄ particles and MWCNTs.

FIG. 3 illustrates scanning electron microscope (SEM) image of free-standing and flexible cathode nanocomposites of LiFePO₄ particles and MWCNTs.

FIG. 4 illustrates photo of free-standing and flexible anode nanocomposites of LTO particles and MWCNTs.

FIG. 5 illustrates SEM image of free-standing and flexible cathode nanocomposites of LiFePO₄ particles and MWCNTs (unpublished).

FIGS. 6 A and B illustrate top view (left) and cross-sectional view (right) of PEO/LiFTSI solid electrolyte films.

FIG. 7 illustrates schematic diagram showing a few steps towards integration of three components to build a full-cell and flexible Li-ion battery.

FIGS. 8 A and B illustrate SEM images of cross-sectional view of the integrated cathode nanocomposite and PEO-based solid electrolyte films.

FIG. 9 illustrates schematic diagram showing a few steps designed for ‘Roll-to-Roll’ process towards mass production of flexible Li-ion batteries.

FIG. 10 illustrates schematic illustration for the preparation of LiFePO₄ particles and LiFePO₄+CNT nanocomposites.

FIG. 11 illustrates XRD patterns of a) LiFePO₄ micrometer-scale particles synthesized by a hydrothermal process under different reaction hours b) LiFePO₄/MWCNT nanocomposites.

FIG. 12 illustrates Raman spectra of a) LiFePO₄ micrometer-scale particles synthesized by a hydrothermal process under different reaction hours b) LiFePO₄/MWCNT nanocomposites.

FIG. 13 illustrates SEM images of LiFePO₄ micrometer-scale particles synthesized by a hydrothermal process under different reaction hours: a) 3 h b) 6 h c) 9 h d) 12 h. SEM images of LiFePO₄/MWCNT nanocomposites for different reaction hours: e) 3 h f) 6 h g) 9 h h) 12 h. All the scale bars are 5 μm.

FIG. 14 illustrates a) Cyclic voltammograms of LiFePO₄ materials for 3 and 12 h b) Half-cell analysis at different discharge rates for 3 and 12 h.

FIG. 15 illustrates SEM images of (a) S1; (b) S2; (c) S3; (d) XRD patterns; (e) Raman spectra of composite electrodes.

| Names | Composite Electrodes |
|---|---|
| S1 | As-prepared LiFePO₄ + CNT + PVDF |
| S2 | LiFePO₄ annealed at 600° C. for 2 h under |
| | Ar-atmosphere + CNT + PVDF |
| S3 | Commercial LiFePO₄ + CNT + PVDF |
| Pristine LiFePO₄ | Commercial LiFePO₄ powders |

FIG. 16 illustrates (a) Stress vs strain curves at room temperature; (b) stress vs strain curves at 80° C.; (c) stress; (d) tan δ— tan δ depicts the damping behavior of the composite electrodes. High tan δ value indicated the more energy dissipation potential. Low tan δ value indicated the more load could be stored rather than energy dissipation; (e) modulus behavior with temperature ramping of composite electrodes.

FIG. 17 illustrates (a) Thermal conductivity and effusivity; (b) Volumetric heat capacity; (c) Electrical conductivity; (d) Cyclic voltammograms of composite electrodes.

FIG. 18 illustrates (a) XRD patterns and (b) Raman spectra of LTO-COM, LTO-BM, LTO-COM BP and LTO-BM BP.

| Names | Compositions |
|---|---|
| LTO-COM | Commercial LTO |
| LTO-BM | As-prepared LTO |
| LTO-COM BP | Commercial LTO composite electrode |
| LTO-BM BP | As-prepared LTO composite electrode |

FIG. 19 illustrates SEM images of (a) LTO-COM, (b) LTO-BM, (c) LTO-COM BP and (d) LTO-BM BP.

FIG. 20 illustrates (a) Cyclic voltammograms at scan rate of 0.1 mVs-1, (b) charge/discharge curves at rate of 0.2 C and inset is showing potential difference between charge and discharge plateaus (c) rate performance at different C-rates and (d) cycling performance at 1C rate for 100 cycles of LTO-COM BP and LTO-BM BP.

FIG. 21 illustrates the uses of Li-ion batteries, preferably for space applications.

FIG. 22 illustrates the objectives to develop Li-ion batteries

FIG. 23 illustrates the methodologies to develop Li-ion batteries.

FIG. 24 illustrates the development of anode based on CNT composites.

FIG. 25 illustrates the characterization of anode nanocomposites.

FIG. 26 illustrates the development of solid electrolyte.

FIG. 27 illustrates the development of solid electrolyte.

FIG. 28 illustrates the summary of development of Li-ion batteries.

FIG. 29 illustrates the on-going development

FIG. 30 illustrates the future work

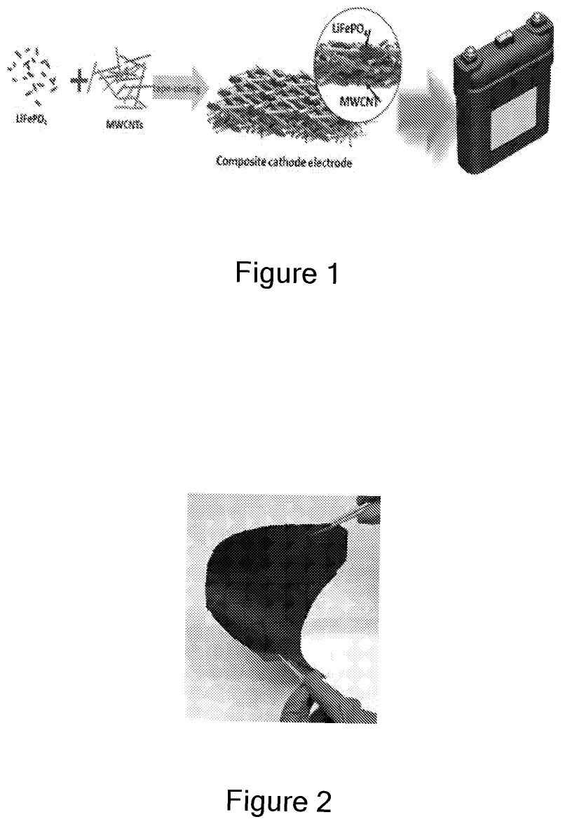

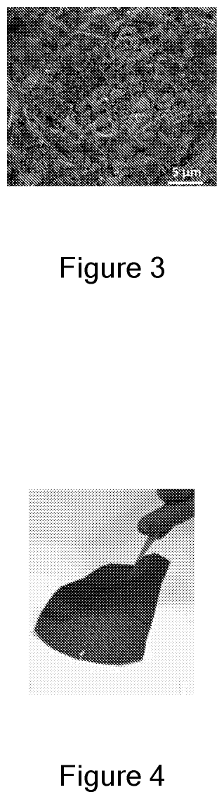

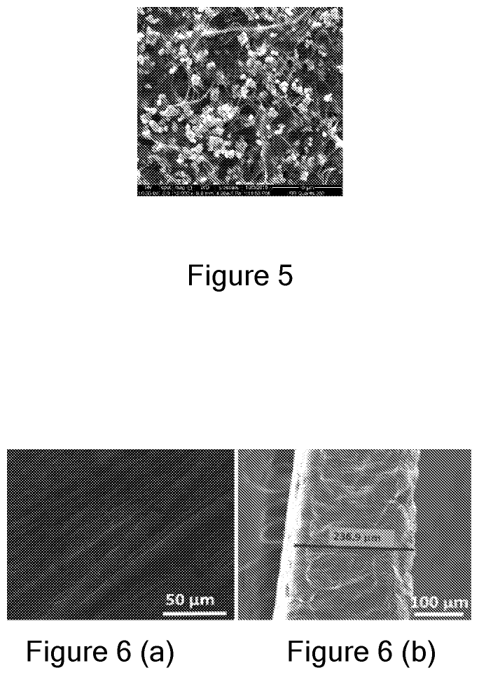

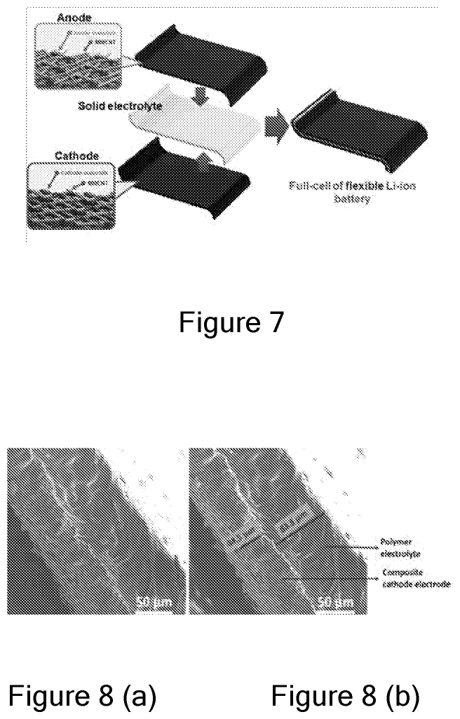

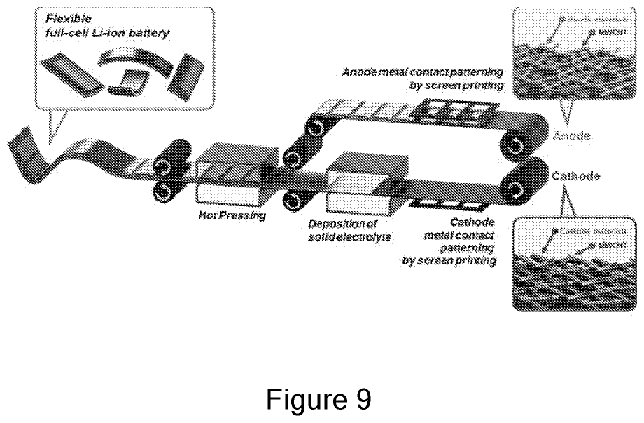

### DETAILED DESCRIPTION OF THE INVENTION

The present invention deals with hydrothermal synthesis of LiFePO₄ micro-particles for fabrication of cathode materials based on LiFePO₄/MWCNT nanocomposites for Li-ion batteries.

Lithium iron phosphate (LiFePO₄) micro-particles (MPs) were synthesized under hydrothermal condition for fabrication of cathode materials based on LiFePO₄ MPs/multi-walled carbon nanotube (MWCNT) nanocomposites. Influence of reaction time for the hydrothermal process on structural, morphological and electrochemical behavior was investigated. Crystal quality was confirmed by X-ray diffraction (XRD) together with Raman analysis. Micrometer scale seeds and capsule-shaped morphology were observed. Such nanocomposite cathodes based on LiFePO₄ MPs/MWCNT were prepared by Surface-engineered Tape Casting technique. The well-crystallized material composed of densely aggregated MPs and interconnected with MWCNTs led to excellent volumetric Li storage properties at a current rate of 0.1 mVs between 2.5 V to 4.3 V. However, the half-cell analysis does not show reasonable capacity values, which may be due to the larger particle size and morphology of synthesized LiFePO₄, resulting in limiting ionic transportation and electronic conduction path.

Experiment

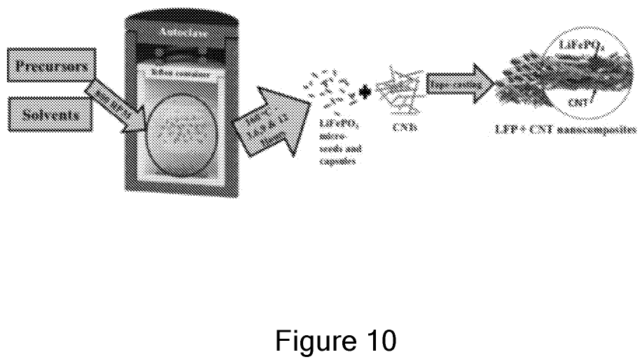

All chemicals were analytical grade, and were used as received. The preparation procedures are shown in FIG. 10. LiFePO₄ particles were prepared by a simple hydrothermal process, under which the precursor solution was prepared with the chemicals of 3 M of LiOOCCH₃, 1 M of FeCl₂, 1 M of L-ascorbic acid, 1 M of H₃PO₄ mixed with 5 mL of de-ionized water/ethylene glycol (volumetric ratio 1/1) medium. L-ascorbic acid acted as a reducing agent to reduce the Fe³⁺ to Fe²⁺ and prevent the oxidation of Fe²⁺. Then the mixture subjected to intensive magnetic stirring at 800 RPM for 1 hour at room temperature. The resulting homogeneous mixture was quickly transferred to a 23 mL Teflon lined stainless steel autoclave and placed in a timer controlled oven. The autoclave was heated and maintained at 160° C. for different reaction hours (3, 6, 9 and 12 h) under air atmosphere. Subsequently, the autoclave was cooled down naturally to room temperature. Precipitates were recovered by centrifugation and washed several times with deionized water and dried at 80° C. in an oven under air atmosphere. The resultant precipitates were characterized by X-ray diffraction (XRD, PANalytical X'pert Pro), Raman spectroscopy (Witec Alpha 300RAS) and scanning electron microscopy (SEM, Nova Nanosem, FEI).

Electrochemical characterization was conducted using 2032 type coin cells. Nanocomposite cathodes based on LiFePO₄ micrometer-scale particles (MPs)/multi-walled carbon nanotubes (MWCNTs) were prepared by tape-casting technique as shown in FIG. 10. Synthesized LiFePO₄ micro-particles and multi-walled carbon nanotubes (MWCNTs) were mixed with the weight ratio of 50:50. Then the mixture was added with Water/Ethanol (volumetric ratio 50/50) solvents and softly grounded for 2 minutes. Further the slurry was transferred to a beaker and sonicated for 10 minutes. While doing sonication, slurry was stirred simultaneously using advanced hot plate stirrers at room temperature for better particles dispersion. LiFePO₄/carbon nanotubes nanocomposites working electrodes has been prepared through surface-engineered tape casting technique with a tape casting blade gap of 3 mm. Before casting, slurry was placed in a vacuum oven for 1 minute for degasification purposes. Further the prepared slurry was coated on copper foil and placed in an oven at 120° C. for 1 h under air atmosphere. After that, the working electrodes has been de-attached from the copper foil and acted as a free-standing working electrode. Cyclic voltammetry was done with multi-channel potentiostat/galvanostat (Princeton Applied Research PMC-1000) without IR compensation. Charge-discharge performances of the prepared coin cells were tested using a battery tester (Maccor Battery Test System Series 4000) inside an environmental chamber (CSZ Model MC-3 Chamber) at a constant temperature of 25° C.

Results and Discussion

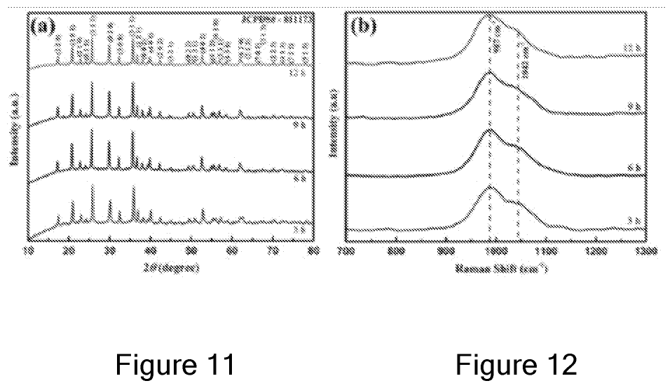

Structural evolution of the synthesized LiFePO₄ materials and LiFePO₄/MWCNT nanocomposites for different reaction hours (3, 6, 9 and 12 h) was investigated by XRD and shown in FIG. 11 a, b. From the FIG. 11a, main diffraction peaks represented the single phase of orthorhombic olivine structure of pure LiFePO₄ (JCPDS #—811173) with the space group of Pnma. All diffraction peaks look like intense, confirming the high order of crystallinity. Average crystallite size was estimated from XRD data as 33.54, 51.07, 49.98 and 43.23 nm for 3, 6, 9 and 12 hours, respectively. XRD patterns of LiFePO₄/MWCNT nanocomposites are shown in FIG. 11b, which illustrate no change in olivine structure of pure LiFePO₄ after the addition of MWCNTs. However, there is no evidence for the presence of carbon because of its low intensity weak peak. Hence, the presence of carbon in the LiFePO₄/MWCNT nanocomposites was confirmed with Raman spectra shown in FIG. 12. FIG. 12 demonstrates a strong band at 987 cm⁻¹ due to internal stretching vibrations of the PO4³⁻ anions of γ-Li₃Fe₂(PO₄)₃ and the weak emission band at 1042 cm⁻¹ because of laser-induced decomposition of olivine LiFePO₄ under air atmosphere. In FIG. 12, strong bands were observed at 1342, 1582 and 2680 cm⁻¹, which are ascribed to D, G and G′ bands respectively. D-band attributed the defects or disorders in the graphene structure, whereas G-band confirmed the presence of graphite carbon. G′-band depicted the second order two-phonon process. The intensity ratio of D and G band (ID/IG) was used to estimate the degree of disorders in the nanocomposite electrodes. The ratios ID/IG of 3, 6, 9 and 12 h were calculated and found 1, 1, 1.01 and 1 respectively. The higher ID/IG ratios implied more defects of the LiFePO₄/MWCNT nanocomposites.

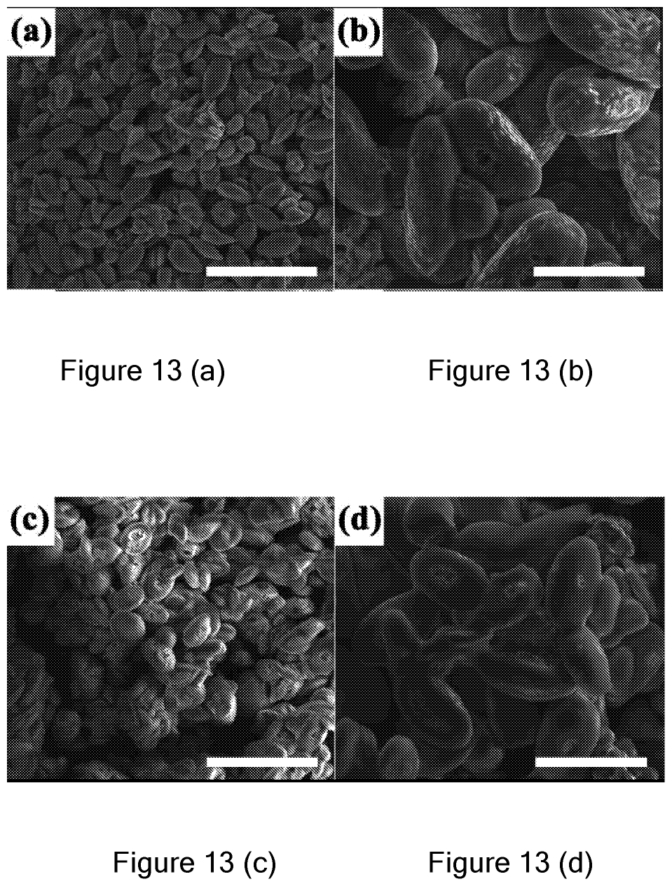

SEM micrographs for LiFePO₄ particles (FIG. 13a-d) and LiFePO₄/MWCNT nanocomposites (FIG. 13e-h for different reaction hours (3, 6, 9 and 12 h) are shown in FIG. 13. Micrometer-scale LiFePO₄ MPs with the shape of ‘seed’ and ‘capsule’ were formed from a shorter reaction time (3 h—FIG. 13a) than others. Morphology of the seed-shaped LiFePO₄ MPs turned to micro-capsule morphology (FIG. 13 b, c & d) while increasing the reaction time, that implies the small changes occurred in LiFePO₄ crystal orientation. In addition, the observed high densely distributed MPs with some pores and tightly packed surface morphology was an advantage for efficient charge carrier separation. SEM micrographs of LiFePO₄/MWCNT nanocomposites confirmed that LiFePO₄ particles are perfectly embedded in an extensive network of MWCNTs, facilitating a highly conductive channel for the mobility of electrons.

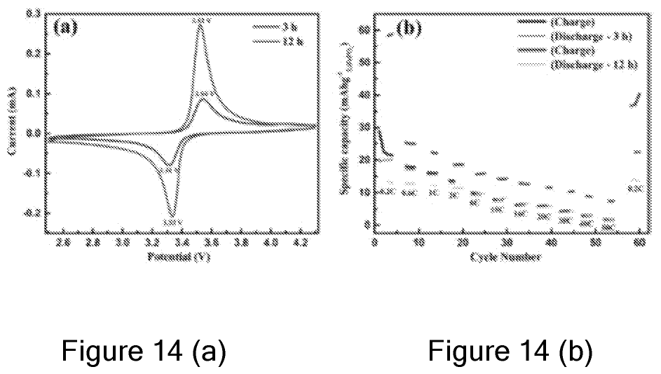

Cyclic voltammetry and half cells analysis of LiFePO₄ materials was conducted and the results were shown in FIG. 14. However, the electrochemical performance for all 3, 6, 9 and 12 reaction hours were almost similar. For comparison, we have reported the initial reaction hours (3 h) and final reaction hours (12 h). Synthesized LiFePO₄ materials were tested at a scanning rate of 0.1 mVs between 2.5 V to 4.3 V (versus Li⁺/Li) and shown in FIG. 14a. A pair of anodic and cathodic peaks were observed which represented the two phase intercalation and deintercalation of Li⁺ ions involving an Fe²⁺/Fe³⁺ redox couple. Cyclic voltammograms exhibited the corresponding anodic peaks at 3.54 and 3.52 V, cathodic peaks at 3.31 and 3.33 V for 3 and 12 hours respectively. The observed small potential separation of 0.23 V for 3 h and 0.19 V for 12 h, which indicated an excellent reversible electrochemical mechanism and good stability during Li insertion and extraction. Further, according to Randles-Sevcik equation, high current range from the redox reactions indicates high Li-ion diffusion during redox reactions. Here in this case, 12 h nanocomposite showed high current (0.32 mA) range compared to 3 h nanocomposite (0.08 mA) which might be capable for the excellent volumetric Li-ion storage and transportation performances.

Half-cell analysis for the synthesized LiFePO₄ cathode materials at different discharge rates was shown in FIG. 14b. Well structural, morphological and electrochemical properties was obtained for the synthesized LiFePO₄ cathode materials. Specific capacity values showed a good stable performance as a function of cycle number for each discharge rate. However, low specific capacity values from the half-cell analysis may be due to the larger particle size and morphology, limited ionic transportation and lack of electron conduction path of synthesized LiFePO₄ cathode materials. Because mobility of the Li-ions in LiFePO₄ particles are mainly depending upon the particle size and morphology. Large particle size blocking the lithium diffusion channel by means of defects, impurities and also increased the channel diffusion length. These factors might have restricted the movement of Li-ions inside the LiFePO₄ particles so that Li-ions cannot hop to their neighbor sites, which might have caused the suppression of Li-ion migration and electronic conduction. Such low Li-ion migration and low electronic conduction might have resulted in capacity loss. During charge and discharge, crystallographic changes and phase boundary movement might occur within the particles that also influenced the capacity loss. So specific capacity losses due to channel blocking and high diffusion path could be minimized for the LiFePO₄ cathode materials with smaller particle size and desired morphologies. It was concluded that the specific capacity loss might be attributed to large particle size and different morphologies.

Conclusion

In summary, micrometer-scale LiFePO₄ particles as cathode materials for Li-ion batteries were synthesized through a simple, cost-effective hydrothermal process. XRD and Raman studies confirmed the high order crystallinity of LiFePO₄ cathode materials. Morphological changes were investigated with SEM analysis. Cyclic voltammograms indicated an excellent reversible electrochemical mechanism during Li insertion and extraction. Larger particle size and morphology, limited ionic transportation and lack of electron conduction path are the possible reasons for capacity loss.

Mechanical Thermal and Electrical Properties of LiFePO₄/MWCNTs Composite Electrodes

Lithium iron phosphate (LiFePO₄)/multi-walled carbon nanotubes (MWCNT) composite electrodes were prepared via a wet-filtration-zipping technique. Mechanical, thermal and electrical properties of the composite electrodes at various temperatures were studied. The composite electrodes exhibited electrical conductivity in the range of 1.1×10¹-3.56×10¹ S/cm. Further, the thermal conductivity, effusivity and volumetric heat capacity were measured. Cyclic voltammograms confirmed good electrochemical performances and high stability during Li⁺ ion intercalation/de-intercalation.

Experiment

LiFePO₄ particles were synthesized by a simple hydrothermal process. A stoichiometric amount of LiOOCCH₃, FeCl₂, L-ascorbic acid, H₃PO₄ was mixed in a 3:1:1:1 molar ratio and added to 5 mL of de-ionized (DI) water/ethylene glycol (volumetric ratio 1/1) medium. Then the mixture was subjected to intensive magnetic stirring at 800 RPM for 1 h and transferred quickly into a 23 mL Teflon-lined stainless steel autoclave and heated at 160° C. for 12 h. After autoclave was cooled down to room temperature (RT), the precipitates were washed several times with DI water and dried at 80° C. overnight. The samples in two different conditions were prepared as (i) as-prepared (Sample 1-S1) and (ii) annealed at 600° C. for 2 h under Ar-atmosphere (Sample 2—S2).

Synthesized LiFePO₄, MWCNT and polyvinylidene fluoride (PVDF) were mixed with the weight ratio of 70:20:10. Then the mixture was added to the DI Water/Ethanol (volumetric ratio 50/50) medium and sonicated for 40 minutes. The prepared slurry was placed in a specific filtration mold and the dimensions of the working electrodes could be controlled. Working electrodes prepared with the dimensions of 5×5 cm and were dried in an oven at 90° C. for 24 h. Commercially available LiFePO₄ powders and commercial LiFePO₄-MWCNT composite electrodes were also prepared for comparison studies. A summary of the prepared samples is illustrated in table 1.

TABLE 1
Names of the composite electrodes

| Names | Composite Electrodes |
|---|---|
| S1 | As-prepared LiFePO₄ + CNT + PVDF |
| S7 | LiFePO₄ annealed at 600° C. for 2 h under |
| | Ar-atmosphere + CNT + PVDF |
| S3 | Commercial LiFePO₄ + CNT + PVDF |
| Pristine LiFePO₄ | Commercial LiFePO₄ powders |

Composite electrodes were characterized by X-ray diffraction (XRD, PANalytical X'pert Pro), Raman spectroscopy (Witec Alpha 300RAS) and scanning electron microscopy (SEM, Nova Nanosem, FEI). Tension (room temperature and 80° C.) and three-point bending (frequency fixed at 1 Hz) properties were measured with Dynamic Mechanical Analyzer (DMA TA Q800).

Thermal measurements were carried out using thermal analyzer (TPS 2500S) under RT. Electrical conductivity (RT and 75° C.) was measured using Hall measurement system (Ecopia HMS-5000). Cyclic voltammetry analysis was conducted with multi-channel potentiostat/galvanostat (Princeton Applied Research PMC-1000).

Results and Discussion

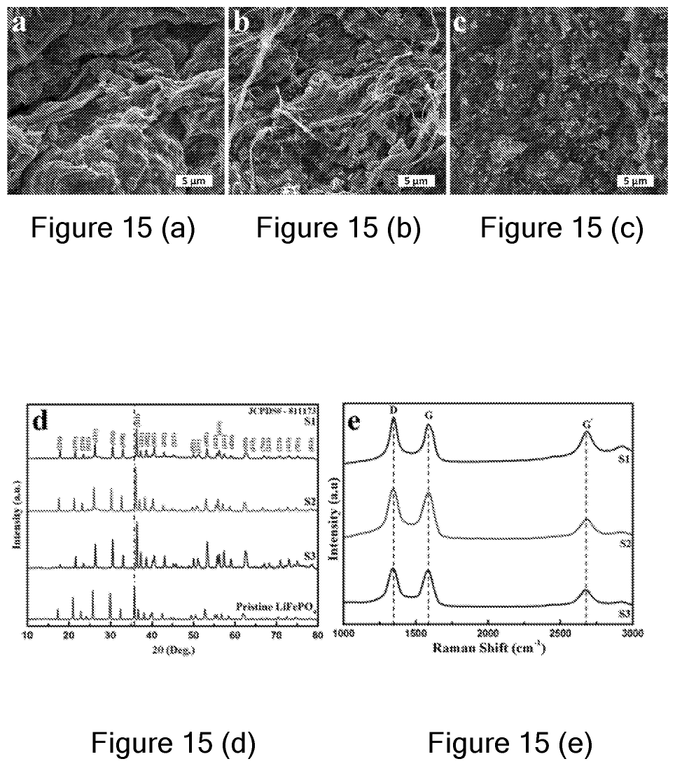

SEM images shown in FIG. 15 (a-c) confirmed the LiFePO₄ particles were perfectly embedded and incorporated in the cross-linked MWCNT matrix. MWCNT matrix was found to be tightly packed with the LiFePO₄ particles in close proximity, facilitating a highly conductive channel for transport of electrons. This tightly packed surface morphology can be an advantage for efficient charge carrier separation which might lead to enhanced mobility of electrons during Li⁺ ions intercalation/de-intercalation. XRD patterns shown in FIG. 15(d) confirmed the presence of LiFePO₄ phase with an ordered olivine structure perfectly matched to the orthorhombic Pnma space group (JCPDS—811173). All diffraction peaks look narrow and sharp, affirmed the high crystalline nature of the composite electrodes. A small peak shifting is observed in LiFePO₄ composite to higher angle due to addition of MWCNT. The presence of carbon in the composite electrodes was evidenced with Raman spectra as shown in FIG. 15(e). Strong bands observed at 1347, 1586 and 2682 cm⁻¹ contributed to the D, G and G′ bands respectively. D-band attributed to the defects or disorders in the graphene structure, whereas Gband confirmed the presence of graphite carbon. G′-band depicted the second order two-phonon process. The ratios ID/IG of S1, S2, and S3 were calculated as 1.02, 1, and 1 respectively. The higher ID/IG ratios implied more defects of the composite electrodes.

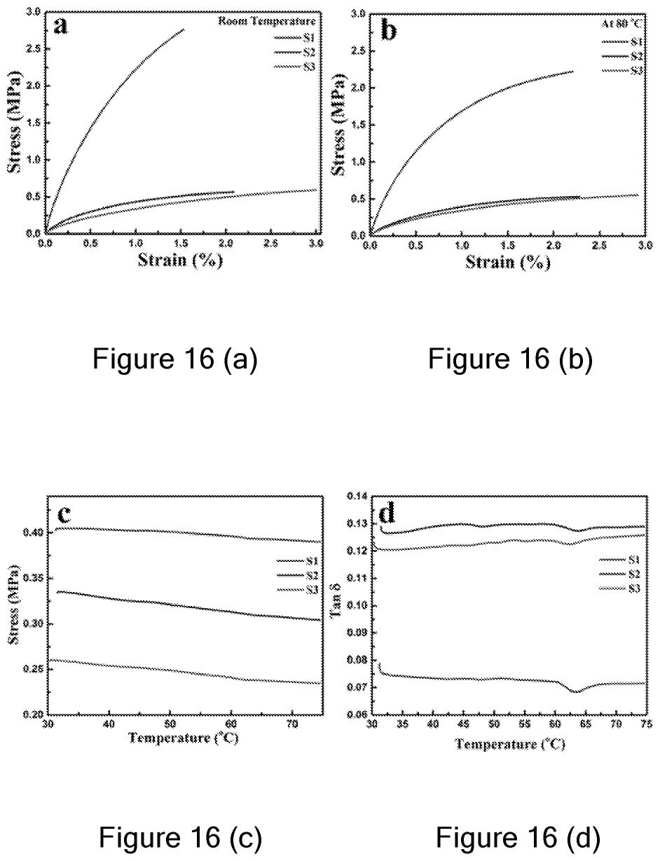

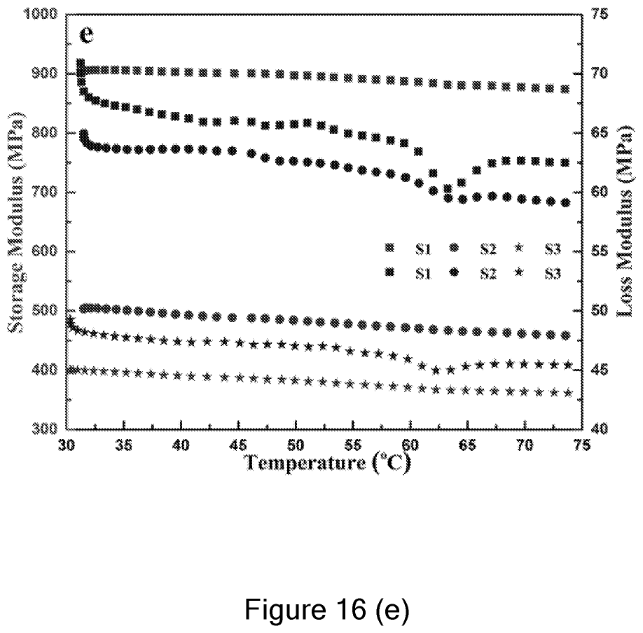

FIG. 16 (a & b) exhibited the stress-strain curves at RT and 80° C. respectively. Both the plots confirmed S1 is showing high stress and low strain value compared with S2 and S3, which represented the brittle properties of S1. In S2, notable reduction of stress and increase in strain value affirmed the flexibility and ductility properties. Young's modulus was calculated as 182, 61, 30 MPa for 51, S2, S3 respectively at RT and 99, 40, 24 MPa for 51, S2, S3 respectively at 80° C. FIG. 16c showed the gradually decreasing stress with increasing temperature, because vibration of molecules due to their internal energy increased the mean distance between molecules reducing the mechanical stress. FIG. 16d depicted the damping behavior of the composite electrodes. High tan δ value indicated the more energy dissipation potential. Low tan δ value indicated the more load could be stored rather than energy dissipation. High tan δ value from S2 composite electrodes represented that it could be stretched more compared with S1 and S3. Low tan δ value for S1 composite electrode represented it could not be stretched more which resulted in the high stiffness and rigid behavior. From FIG. 16e, storage and loss modulus continuously decreased with increasing temperature. High storage modulus also confirmed the rigid behavior of S1 and low storage modulus supported the ductile behavior of S2 and S3. A similar trend has been observed in loss modulus that confirmed the low loss modulus values of S2 and S3 indicated the ductile behavior. All the mechanical analysis confirmed S2 composite electrodes exhibited good mechanical performances compared with S1.

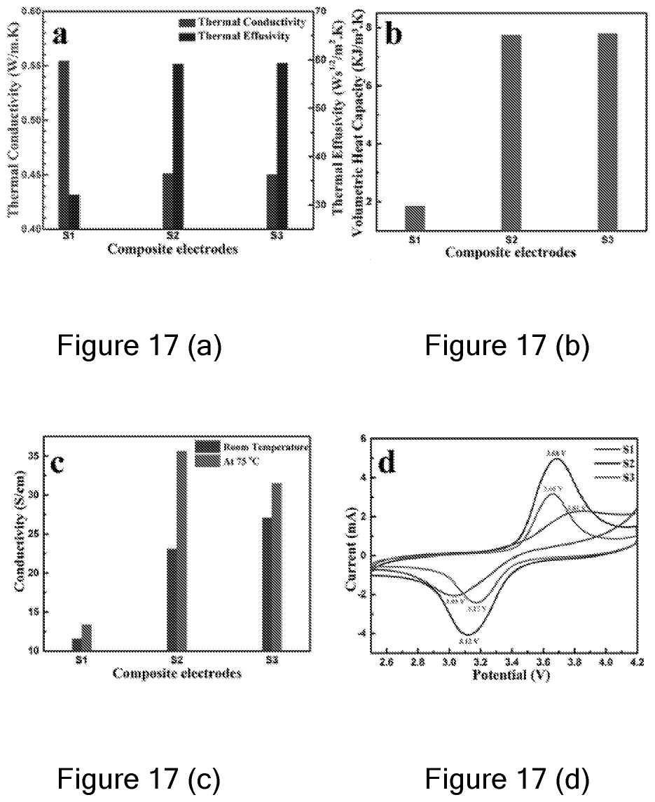

Thermal, electrical and electrochemical properties for the composite electrodes are shown in FIG. 17. FIG. 17a indicated the thermal conductivity values in the range from 0.55 to 0.45 W/mK which is higher than that of previous reported value. High thermal effusivity and volumetric specific capacity values confirmed the S2 composite electrode could store a large degree of heat energy without undergoing a phase transition compared with S1. FIG. 17c affirmed the electrical conductivity of the composite electrodes at RT and 75° C. Electrical conductivity has been determined as the range from 1.16 to 2.71×101 S/cm at RT and 1.34 to 3.56×10¹ S/cm at 75° C. It was 2 orders of magnitude higher than those of reported values 2.3×10⁻¹ S/cm and 1×10⁻¹ S/cm. Electrical conductivity increased with the increasing of temperature, because electrons oscillated and acquired sufficient energy to move the conduction band from valance band. Thus, the electrons could move freely for conduction and drastically lowered the resistance. FIG. 17d exhibited the cyclic voltammograms of composite electrodes at a scanning rate of 0.1 mV/s between 2.5 V to 4.2 V (versus Li⁺/Li). Well-defined anodic and cathodic peaks corresponded to the two phase intercalation/de-intercalation of Li⁺ ions involved the Fe²⁺/Fe³⁺ redox reaction. In addition, small potential peak separation between the anodic and cathodic waves demonstrated the stability of Li⁺ ions during intercalation/de-intercalation.

Conclusions

LiFePO₄/MWCNT composite electrodes were prepared through a wet-filtration-zipping technique. SEM images confirmed the LiFePO₄ particles were perfectly embedded and incorporated in the cross-linked MWCNT matrix. High damping value and low storage modulus affirmed the high mechanical performance of the composite electrode with annealed LiFePO₄ particles. High thermal, electrical and electrochemical performances promise the S2 composite electrode as an excellent candidate for cathode materials of Li-ion battery.

Enhanced Electrochemical Performance of MWCNTs Supported Free-Standing LTO Composite Electrode

Spinel-Li₄Ti₅O₁₂/multi-walled carbon nanotubes composite electrodes were prepared via novel and cost-effective surface engineered tape casting technique and well compared with commercially available LTO. The structural, morphological and electrochemical properties of LTO and its composite electrodes were studied. The enhanced electrochemical performance of as-prepared LTO is mainly related to the homogeneous distribution of particles and its small size which facilitates large amount of active sites for lithium insertion and also short diffusion paths to operate at high current.

Experimental

LTO was synthesized by wet-milling route using 1.073 g of Li₂CO₃ (Sigma-Aldrich) and 2.897 g of TiO₂ (VWR, <500 nm) as lithium and titanium sources, respectively with ethanol (Sigma Aldrich) as media. All the precursors were ball-milled at 400 rpm for 5 h using full directional planetary ball mill (Tencan QXQM-0.4). The resulting mixture was dried in air and later calcined at 850° C. for 26 h in muffle furnace, followed by grinding for 1 h and named as LTO-BM. The commercial LTO (EQ-Lib-LTO-1, MTI Corp, USA) was used for comparison study and named as LTO-COM.

MWCNTs supported LTO free-standing composite electrodes were prepared by surface engineered tape-casting technique. LTO-BM/LTO-COM, MWCNTs, and carboxymethyl cellulose with the weight ratio of 70:25:5 were mixed with water/ethanol (volumetric ratio 50/50). Later, the slurry was ground for 2 minutes and sonicated for 10 minutes with continuous stirring. The slurry was coated on copper foil and placed in an oven at 120° C. for 1 h. The electrode was de-attached from the copper foil and acted as a free-standing working electrode. The composite electrodes are named as LTO-BM BP and LTO-COM BP for LTO-BM and LTOCOM, respectively and tabulated in Table 1.

TABLE 1
Sample names and its compositions

| Names | Compositions |
|---|---|
| LTO-COM | Commercial LTO |
| LTO-BM | As-prepared LTO |
| LTO-COM BP | Commercial LTO composite electrode |
| LTO-BM BP | As-prepared LTO composite electrode |

LTO and MWCNTs-supported LTO composite electrodes were characterized by powder X-ray diffraction (XRD, PANalytical X'pert Pro), Raman spectroscopy (Witec Alpha 300RAS) and scanning electron microscopy (SEM, Nova Nanosem, FEI). Coin cells of 2032-type were assembled in half-cell (working electrode against lithium) configuration with 1 M LiPF₆ in EC:EMC (1:1 vol %) with 2 wt % FEC electrolyte inside glovebox (MBraun MB-Labstar 1450/780). Cyclic voltammetry (CV) was carried out with multi-channel potentiostat/galvanostat (Princeton Applied Research PMC-1000) at a scanning rate of 0.1 mVs⁻¹ between 1 V to 2 V (versus Li⁺/Li) without IR compensation. Charge-discharge performance was tested using a battery tester (Maccor Battery Test System Series 4000) at room temperature (RT).

Result and Discussion

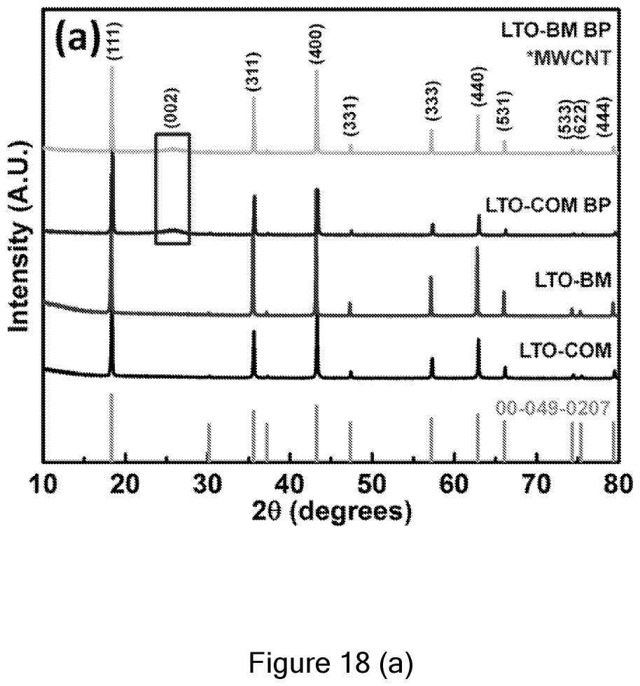

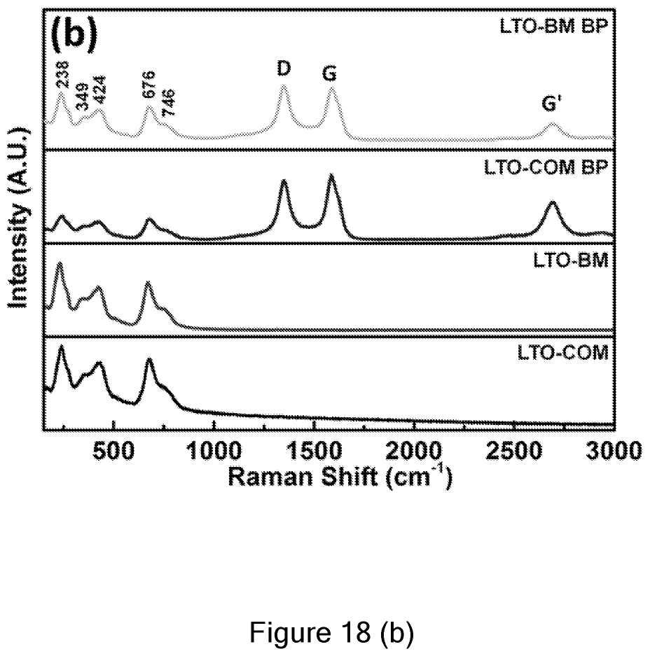

XRD patterns for LTO and MWCNTs-supported LTO composite electrodes were shown in FIG. 18a. All diffraction peaks are sharp confirming the high crystalline and pure phase face-centered cubic spinel LTO with a space group of Fd3m, which is in well-accordance with the JCPDS card no. 00-049-0207. A broad peak around ˜26° was observed for composite electrodes, due to the presence of carbon, and it does not influence the structural changes in LTO. Average crystallite sizes were calculated from Debye-Scherrer equation D=0.9λ/B cos θ and found to be 66 and 71 nm for LTO-COM and LTO-BM, respectively, where ‘D’ is the average crystallite size, ‘λ’ is the wavelength of X-ray, ‘B’ is the full width half maximum value in radian and ‘θ’ is the diffraction angle. Further, affirming the structural information and quality of graphitic carbon, Raman analysis was performed and Raman spectra are shown in FIG. 18b. The characteristic peaks observed for LTO at 676 and 746 cm⁻¹ were due to the vibrations of Ti—O bonds in TiO₆ octahedral. The peaks at 238, 424 and 350 cm⁻¹ confirmed the presence of O—Ti—O, Li—O bonds, respectively. Furthermore, strong peaks are observed at 1348, 1583, and 2693 cm−1, corresponding to D, G, and G′ bands respectively, which are the characteristic peaks of carbon materials.

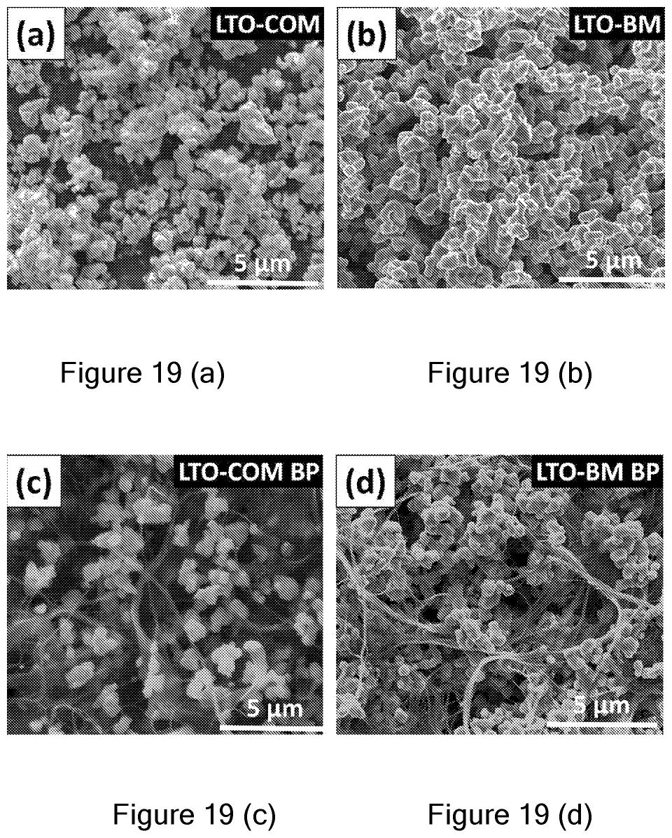

For the investigation of morphological properties SEM analysis was performed and images are shown in FIG. 19. From FIG. 19 (a, b), it can be clearly seen that LTO-BM has uniform and homogeneous particle size, shape and distribution compared to LTO-COM. The MWCNTs supported LTO composite electrodes are shown in FIG. 19 (c, d) which indicates that LTO particles are perfectly embedded in MWCNTs conductive matrix in a close proximity range, thereby producing a robust inner-connected architecture. In such inner-connected architecture, the MWCNTs act as a fast transmission conductive network to connect the LTO particles, which favors for enhanced electric and ionic transfer during electrochemical reactions. Electrical conductivity was measured using Hall-measurement (Fig. not shown) and found to be 30.5 and 28.3 Scm⁻¹ for LTO-BM BP and LTO-COM BP respectively, and electrical conductivity of both LTO-BM BP and LTO-COM BP is found to be higher than that of previously reported carbon coated LTO.

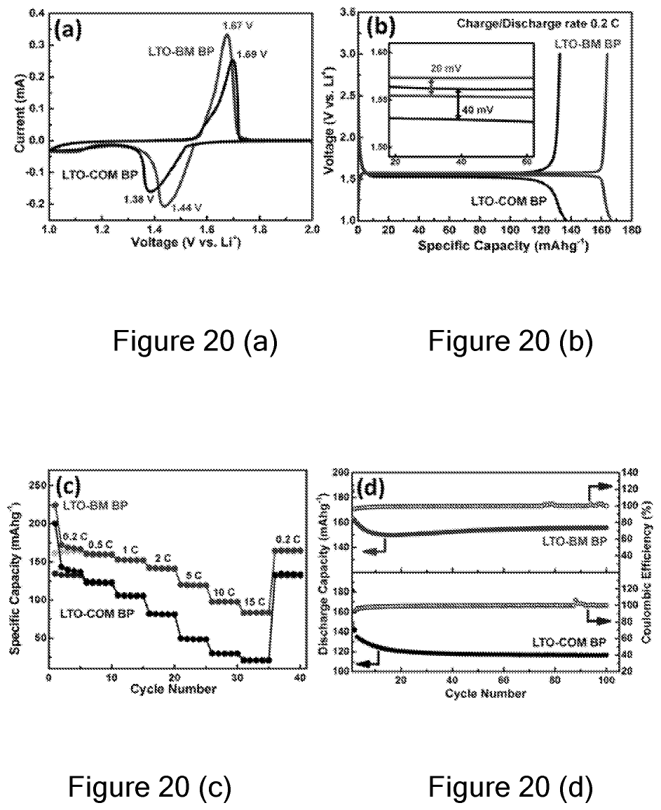

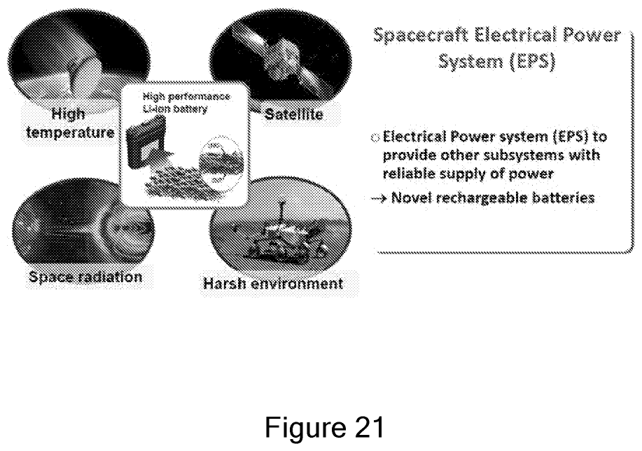

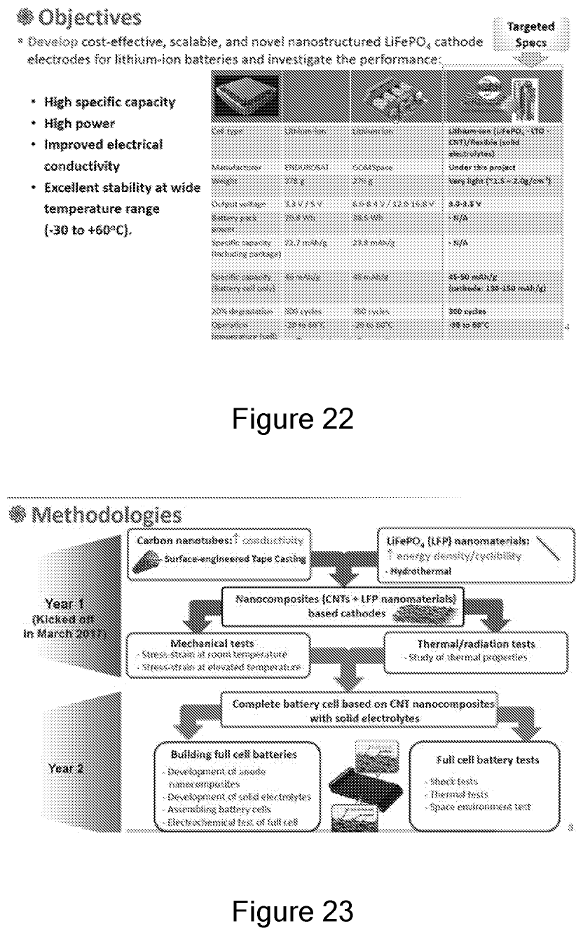

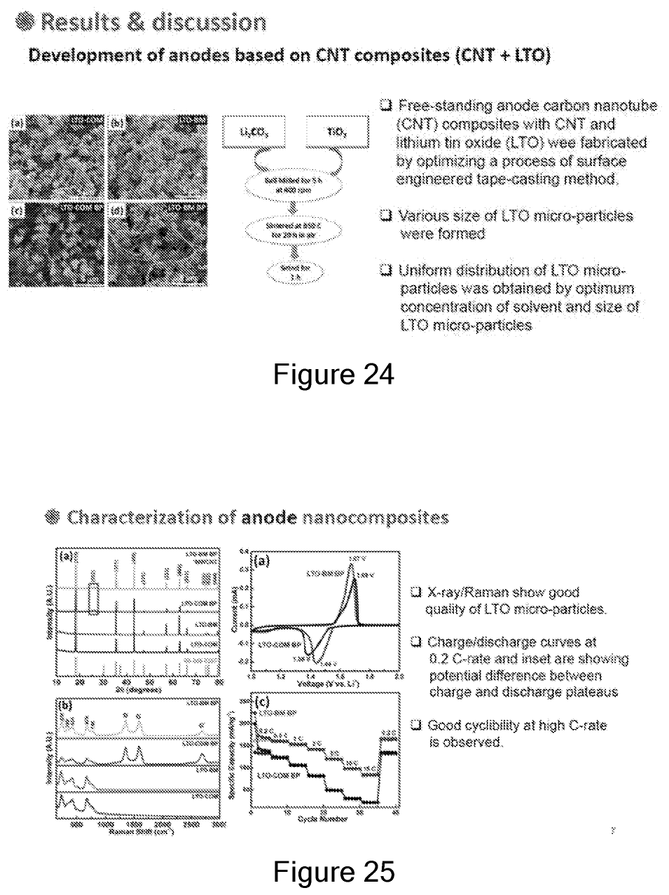

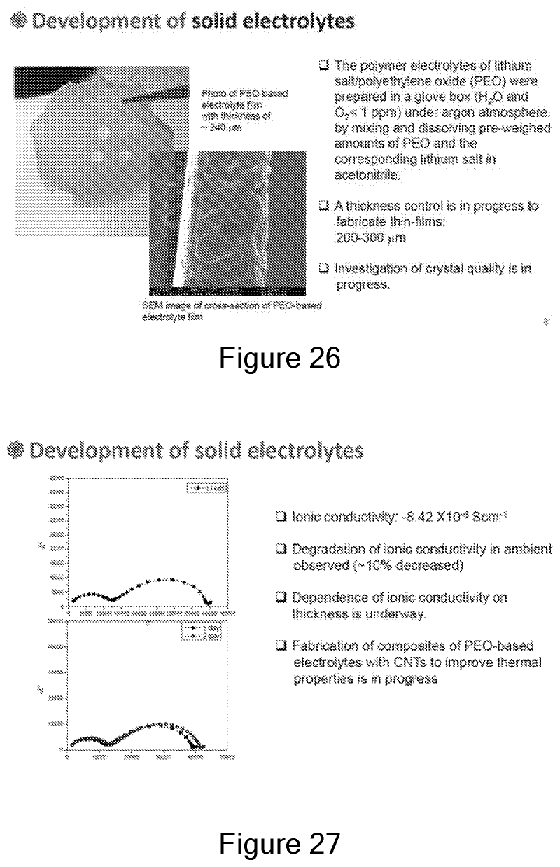

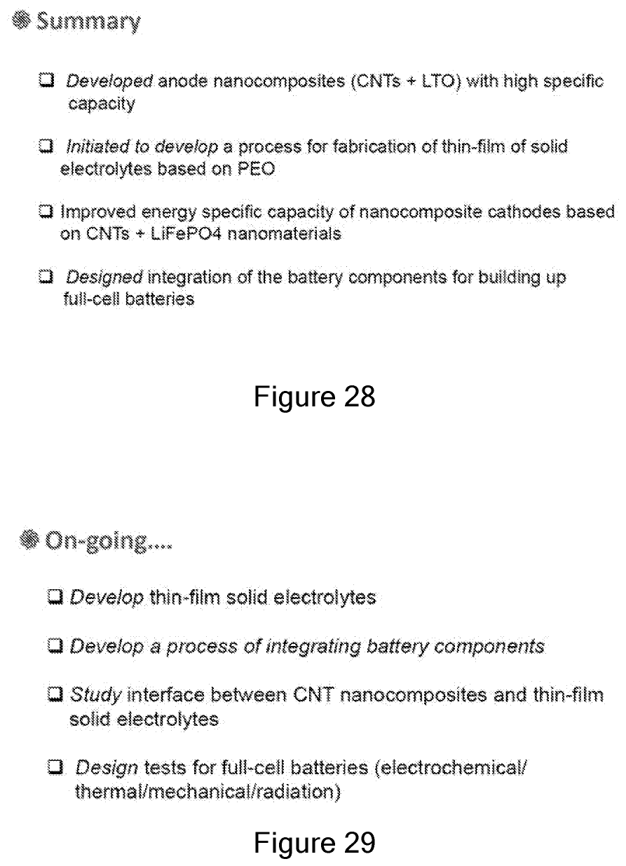

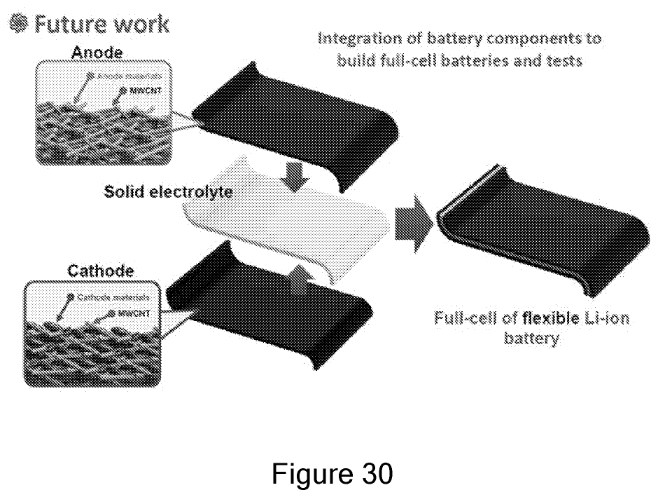

The CV curves of composite electrodes are shown in FIG. 20a which has one pair of reversible redox peaks between 1.0-2.0 V. The LTO-BM BP electrode showed oxidation and reduction peaks at 1.67 and 1.44 V whereas for LTO-COM BP electrode it was observed at 1.69 and 1.38 V. The peak potential difference between oxidation and reduction peaks was 0.23 V for LTO-BM BP and 0.31 V for LTO-COM BP, indicating lesser polarization in LTO-BM BP electrode. Further, higher peak of LTO-BM BP electrode compared with that of LTO-COM BP reflects higher Li ion diffusion and lower internal resistance. The initial voltage profiles at 0.2 C (1C=175 mAhg⁻¹) are presented in FIG. 20b for both composite electrodes between 1.0 to 3.0 V vs. Li⁺/Li. The lengthened voltage plateau for LTO-BM BP electrode is mainly attributed to excellent electrode kinetics and higher electrochemical reactivity of as-prepared LTO exhibiting higher capacity (166 mAhg⁻¹) than that of LTO-COM BP (137 mAhg⁻¹). Furthermore, the potential difference (ΔV) in charge/discharge curves for LTO-BM BP electrode is lesser than LTO-COM BP displaying lower polarization potential (shown in inset of FIG. 20b) which is in well accordance with CV analysis in previous section. The rate capability of composite electrodes has been extensively probed from 0.2C to 15C (shown in FIG. 20c). It can be clearly seen that LTO-BM BP electrode shows higher capacity than LTO-COM BP at each Crate. LTO-BM BP electrode exhibited a good rate performance with a capacity of ˜120 mAh g⁻¹ at a relatively high rate of 5 C, whereas LTO-COM BP electrode showed the same capacity at a very low C rate i.e. 0.5 C. Further, to ensure the capacity retention of both electrodes, cyclic performance have been performed at 1 C rate for 100 cycles and shown in FIG. 20d. The LTOBM BP and LTO-COM BP showed discharge capacity of ˜155 mAhg⁻¹ and 105 mAhg⁻¹ at 1C-rate and retains nearly 100% even after 100 C-D cycles. The overall improved performance of LTO-BM compared to LTO-COM, even at high C-D rate is mainly attributed to its uniform, homogeneous and smaller particles, lower polarization resistance, excellent electrode kinetics and electrochemical stability.

MWCNT-supported LTO free-standing electrodes were prepared through surface-engineered tape casting technique. Structural properties were confirmed with XRD and Raman studies. SEM confirms the formation of uniform and homogeneous of LTO particles and their well crosslinking with MWCNTs matrix. Enhanced performance of as prepared LTO-BM shows its potential application towards commercialization.

1. A hydrothermal process of preparing lithium ion phosphate (LiFePO₄) micrometer-scale and nanometer-scale particles, wherein the hydrothermal process comprises the steps of:
preparing a precursor solution;
mixing de-ionized water with the precursor solution forming a mixture;
subjecting the mixture to intensive magnetic stirring; and
recovering precipitates of the mixture by a process of centrifugation.

2. The hydrothermal process according to claim 1, wherein the precursor solution comprises:
3 M of LiOOCCH₃;
1 M of FeCl₂;
1 M of L-ascorbic acid; and
1 M of H₃PO₄.

3.-4. (canceled)

5. The hydrothermal process according to claim 2, wherein the L-ascorbic acid acts as a reducing agent to reduce Fe⁺ ions to Fe⁺ ions, thereby preventing oxidation of Fe⁺ ions within the mixture.

6. The hydrothermal process according to claim 1, wherein subjecting the mixture to intensive magnetic stirring comprises stirring the mixture at 800-1000 revolutions per minute for a duration of 1 hour at room temperature.

7.-10. (canceled)

11. The hydrothermal process according to claim 1, wherein recovering the precipitates comprises washing the precipitates three times with deionized water.

12. The hydrothermal process according to claim 1, further comprising drying the recovered precipitates at 80° C. to form LiFePO₄ micrometer-scale and nanometer-scale particles.

13. The hydrothermal process according to claim 1, further comprising confirming a crystal orientation of the recovered precipitate using X-ray diffraction, Raman spectroscopy, or scanning electron microscopy to confirm a crystal orientation of the recovered precipitates.

14. The hydrothermal process according to claim 13, wherein the crystal orientation of the recovered precipitates depends on a duration of the hydrothermal process.

15. (canceled)

16. A composite electrode comprising:
lithium ion phosphate (LiFePO₄);
multi-walled carbon nanotubes (MWCNT); and
polyvinylidene fluoride (PVDF).

17. (canceled)

18. A method of manufacturing the composite electrode according to claim 16, the method comprising the steps of:
mixing synthesized LiFePO₄ particles with ethanol to form a mixture;
grinding the mixture softly using mortar and pestle forming a slurry;
transferring the slurry to a beaker and sonicating the slurry;
coating the slurry on copper foil and baking the copper foil in an oven; and
detaching the composite electrode from the copper foil.

19. The method of manufacturing the composite electrode according to claim 18, wherein the mixture comprises synthesized lithium ion phosphate (LiFePO₄) particles, multi-walled carbon nanotubes (MWCNT), and polyvinylidene fluoride (PVDF).

20. (canceled)

21. The method of manufacturing the composite electrode according to claim 19, wherein the synthesized lithium ion phosphate (LiFePO₄) particles, the multi-walled carbon nanotubes (MWCNT), and the polyvinylidene fluoride (PVDF) are mixed in a weight ratio of 70:20:10 respectively.

22. The method of manufacturing the composite electrode according to claim 18, wherein the mixture is annealed at 600° C. for 2 hours in an Argon (Ar)-atmosphere.

23. The method of manufacturing the composite electrode according to claim 18, wherein the slurry is sonicated for 10 minutes.

24. The method of manufacturing the composite electrode according to claim 18, wherein the slurry is degasified for 1 minute in a vacuum oven.

25.-29. (canceled)

30. A free-standing composite electrode comprising:
spinel-Li₄Ti₅O₁₂ (LTO);
multi-walled carbon nanotubes (MWCNTs); and
carboxymethyl cellulose.

31. A method of manufacturing the free-standing composite electrode of claim 30, the method comprising the steps of:
mixing Spinel-Li₄Ti₅O₁₂ (LTO), multi-walled carbon nanotubes (MWCNTs), and carboxymethyl cellulose with water or ethanol to form a slurry;
grinding and sonicating the slurry;
coating the slurry on copper foil and placing the slurry in an oven at 120° C. forming an electrode; and
detaching the electrode from the copper foil to form a free-standing composite electrode.

32. The method of manufacturing according to claim 31, wherein a method for preparing spinel-Li₄Ti₅O₁₂ (LTO) free-standing composite electrodes comprises:
synthesizing a precursor solution through a wet-milling technique resulting in a mixture;
drying the mixture in air and calcinating the mixture at 850° C.; and
grinding the calcinated mixture.

33. The method of manufacturing according to claim 32, wherein the precursor solution comprises 1.073 g of Li₂CO₃ and 2.897 g of TiO₂.

34. The method of manufacturing according to claim 31, wherein the slurry is ground for 2 minutes and sonicated for 10 minutes.

35.-38. (canceled)
